(19) United States
(12) Patent Application Publication
(10) Pub. No.: US 2010/0038219 A1
(43) Pub. Date: Feb. 18, 2010

(54) ELECTRONIC SIGNALLING SYSTEM

(76) Inventor: YITZCHAK COHEN, D.N. HANEGEV (IL)

Correspondence Address: DEBORAH A. GADOR, P.O. BOX 4133, GANEL TIKVA, 55900, IL

(21) Appl. No.: 12/541,995

(22) Filed: Aug. 17, 2009

(30) Foreign Application Priority Data
Aug. 18, 2008 (IL) 193521

(51) Int. Cl. H01H 19/00

(52) U.S. Cl. 200/11 R

(57) ABSTRACT

The present invention relates to an electronic signaling system utilizing a multi-contact switch that is activated by a mechanical activity which is converted to electrical signaling. The electrical signal activates an electric motor which, in turn, closes, in a predetermined sequence, a series of electronic circuits, which generate a series of electrical signals. The multi-contact switch according to the present invention, may replace a human user who would otherwise generate these electric signal by pressing a series of buttons in a predetermined sequence.

### FIELD OF THE INVENTION

The present invention relates to an electronic signaling system, in general, and, in particular, to an electronic signaling system utilizing a multi-contact switch.

### BACKGROUND OF THE INVENTION

Multi-contact switches are known in the art for close circuiting a multiplicity of electrical circuits.

It would be desirable to have such a switch that can be operated in a preselected order.

### SUMMARY OF THE INVENTION

The present invention relates to an electronic signaling system including a multi-contact switch having a plurality of pairs of contacts, an electric contact for selectively engaging one of said pairs of contacts, the pairs of contacts being electrically coupled to an electronic device for generating signals. The system further includes a motor for moving the electric contact to engage the pairs of contacts in a pre-selected sequence, and means for generating an electrical signal for powering said electrical device.

According to one embodiment of the present invention, the motor is an electric motor.

According to one embodiment of the present invention, the system the electric contact is adapted for selectively engaging at least two of the pairs of contacts in a pre-selected sequence.

According to another embodiment of the present invention, the system further including a plurality of multi-contact switches.

According to yet anther embodiment of the present invention, the plurality of multi-contact switches is driven by a single motor.

According to an embodiment of the present invention, the electric contact is electronically controlled by a switch adapted for selectively electrically coupling the pairs of contacts.

According to an embodiment of the present invention, the multi-contact switches are coupled to a mechanism mounted on a shaft of said motor, selectively locking said arm of multi-contact switch, thereby permitting the rotational movement of the motor to be transferred to the arm of said multi-contact switch.

The present invention also relates to a method for electronic signaling, the method including providing a multi-contact switch including a plurality of pairs of contacts, electrically coupling the pairs of contacts to an electronic device for generating signals, mounting an electric contact on the multi-contact switch for selectively engaging one of the pairs of contacts, and generating an electrical signal for powering an electrical device for moving the electric contact to engage the pair of contacts.

### BRIEF DESCRIPTION OF THE DRAWINGS

The present invention will be further understood and appreciated from the following detailed description taken in conjunction with the drawings in which:

FIG. 1 is a schematic perspective illustration of a multi-contact switch, constructed and operative in accordance with one embodiment of the present invention;

FIG. 2 is a schematic bottom perspective illustration of the switch of FIG. 1;

FIG. 3 is a schematic illustration of an electronic signaling system, according to one embodiment of the invention; and

FIG. 4 is a bottom view of an electronic signaling system constructed and operative in accordance with an alternative embodiment of the present invention.

### DETAILED DESCRIPTION OF THE INVENTION

The present invention relates to an electronic signaling system utilizing a multi-contact switch that is activated by a mechanical activity which is converted to electrical signaling. Examples of such mechanical activities include pressing a door knob or a car door handle or opening or closing a door, activating vehicle brakes, etc. The electrical signal activates an electric motor which, in turn, closes, in a predetermined sequence, a series of electronic circuits, which generate a series of electrical signals. The multi-contact switch according to the present invention, may replace a human user who would otherwise generate these electric signal by pressing a series of buttons in a predetermined sequence.

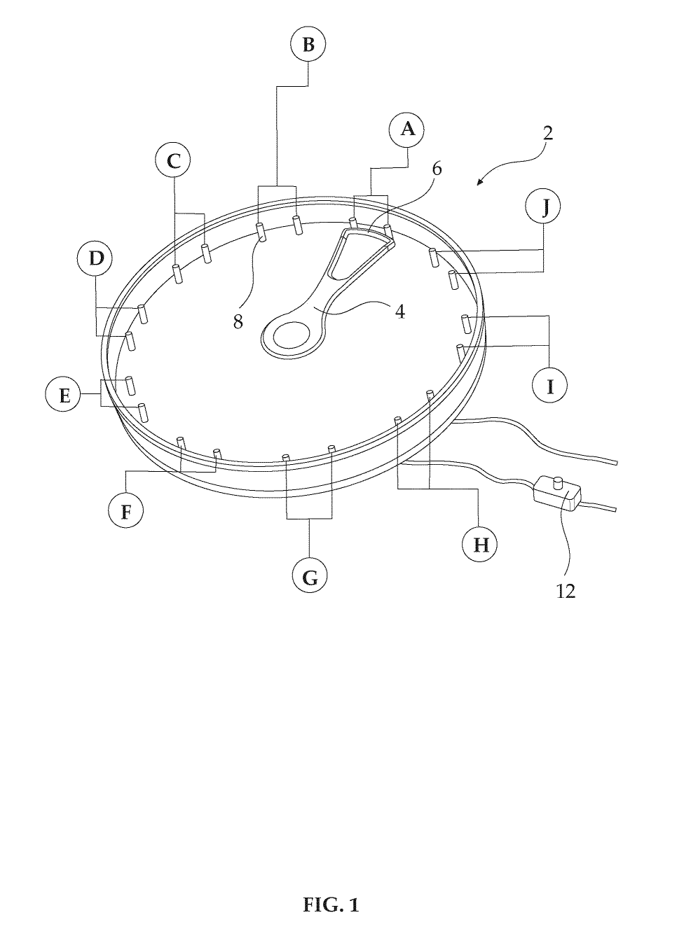

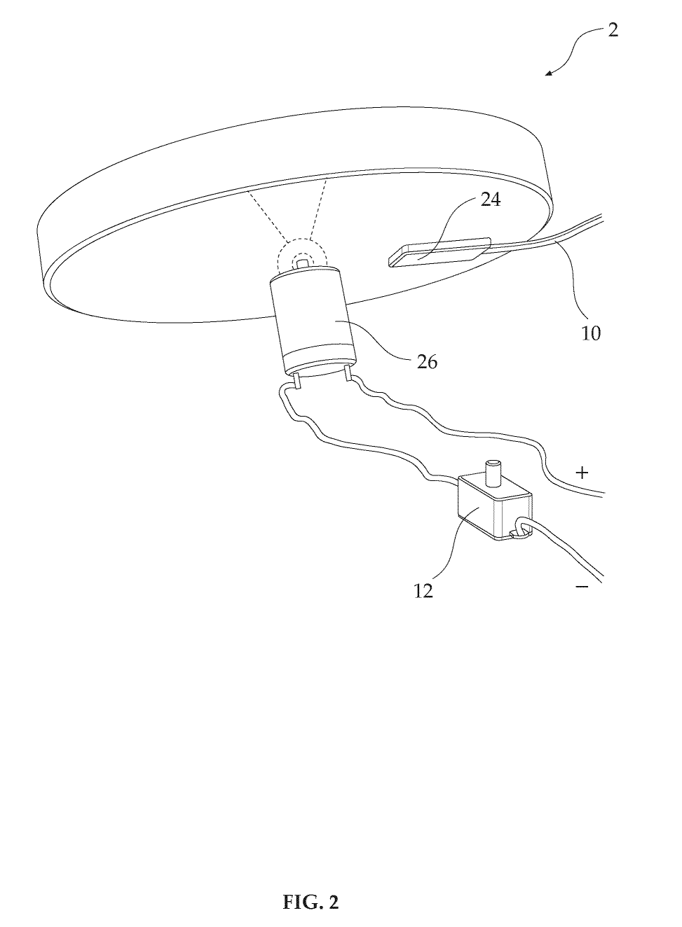

One embodiment of this invention is an electronic signaling system where a mechanical activity closes a switch which allows a power supply line to activate an electrical actuator, such as a motor, which, in turn, causes an arm to rotate and close a series of circuits. One example of such a system 1 is shown in FIGS. 1 and 2, in respective top and bottom perspective views. In this embodiment, a multi-contact switch 2 is provided having pairs of circuit contacts 8, illustrated as A, B, C . . . J, arranged thereabout. An arm 4 having an electric contact 6 is provided for selectably coupling pairs of contacts to close one or more circuits, one at a time, in a pre-defined order. In the embodiment of FIGS. 1 and 2, a motor 26 is coupled to arm 4, for rotation of the electric contact 6 when mechanically activated. In this embodiment, the mechanical activity closes operating switch 12, which activates the motor 26. Each circuit, when closed, sends a signal over a pair of wires 10, which actuates an operation of an electronic device.

Preferably, motor 26 is a programmable step motor, which executes a pre-determined set of steps according to the program, by closing the contacts in a pre-defined sequence. The particular sequence is determined by the particular actuating switch (mechanical activity).—Using a step motor allows for controlling its speed and rotation direction, as it rotates in a series of discrete steps. Alternatively, the motor may be an electric motor or any other motor

It is a particular feature of the invention that a series of operations can be initiated by the mechanical actuator in response to a single mechanical activity or by a sensor when detecting a certain change in the environment, such as motion, temperature, light, etc, as known.

This activity sends a signal by physically operating switch 12 to activate motor 26 causing it to turn moving arm 4 with electric contact 6. The wires 10 are coupled to contacts 8 via a contact box 24. The other end of wires 10 are coupled to an electric or electronic device for providing an output signal. It will be appreciated that, alternatively, multi-contact switch 2 may be a series of contact pairs linearly aligned and the motor rotation may be converted into a linear movement of the electric contact closing the pair of contacts in a pre-defined sequence.

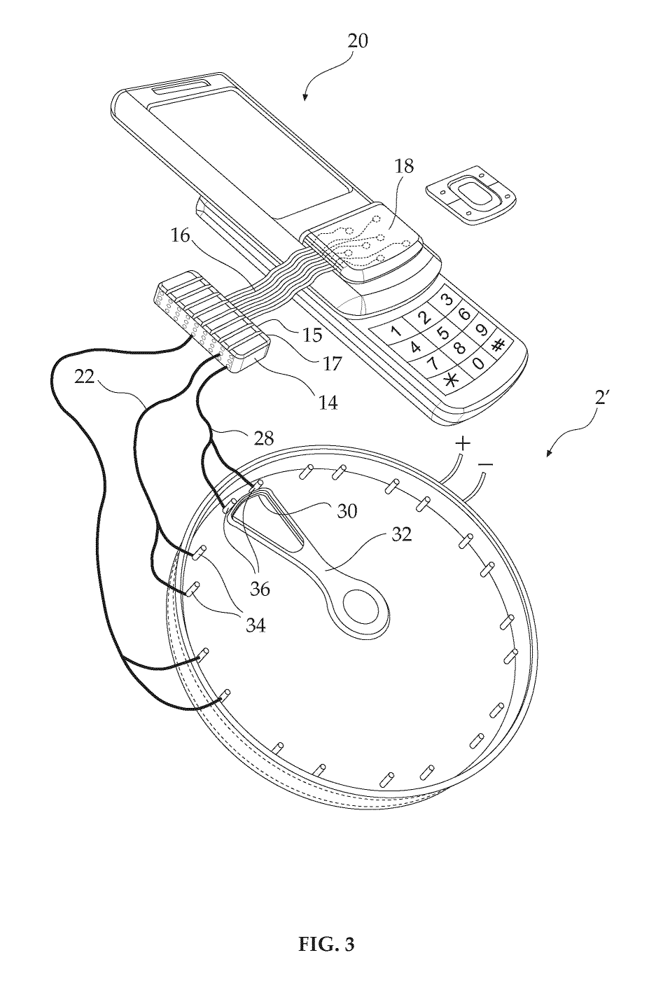

Referring now to FIG. 3, there is shown a schematic illustration of a system 2′ for providing electronic signaling, according to one embodiment of the invention. In this illustrated example, wires 22 from contacts 24 are connected via a terminal 14 to a plurality of micro-switch contacts 18 in a cellular phone 20 via a pair of wires from a plurality of wires 16. According to a preferred embodiment of the invention, a first pair of contacts is coupled via wires 22 to a first terminal contact 15 in terminal 14, from which an outgoing pair of wires from a plurality of wires 16 is coupled to a first micro-switch contact 18. A second pair of contacts 26 in the series is coupled via a pair of wires 28 to a second terminal contact 17 in terminal 14, which is also connected to the cellular phone 20. Similarly, additional pairs of contacts may be connected to cellular phone 20 via terminal 14, if desired. It will be appreciated that the wires may be a ribbon cable or any other electric conductors known in the art. It will be further appreciated that the multi-contact switch may include internal wiring which allow for using connectors and terminals instead of welding each contact separately.

When one of the pre-defined mechanical activities occurs, moving arm 32 is moved or rotated by the programmed step motor according to the pre-programmed set of steps, and closes the pairs of contacts in the pre-selected sequence. This causes electric contact 30 on arm 32 to electrically engage a first pair 24 of contacts, closing a first circuit, in a series of circuits, which causes the cellular phone to perform an operation, i.e., initiate a first step in a series of steps for sending an SMS message or a cellular call to a first person. As the arm 32 continues to rotate by means of the pre-programmed step motor, a second circuit is closed when pair 26 of contacts is electrically engaged by electric contact 30. This, in turn, initiates a second step in the series of steps. Thus, each operation is activated in its turn until the program is complete and the desired signal has been sent to the desired recipient.

It will be appreciated that the arrangement of this multi-contact switch replaces the need for a user to press the various micro-switches on a cell phone in order to send a message to the recipient.

In another example, the electronic signaling system utilizing a multi-contact switch according to the present invention may be used to take a photograph of a burglar and automatically send the photograph to a pre-defined recipient. The motor in that case may be activated by a sensor, such as a motion sensor.

In yet another example of the present invention, the multi-contact switch may be used to activate a loudspeaker of a cellular phone positioned in a vehicle. The cellular loudspeaker may be used to communicate with a thief in a stolen vehicle, intimidating him to return the car.

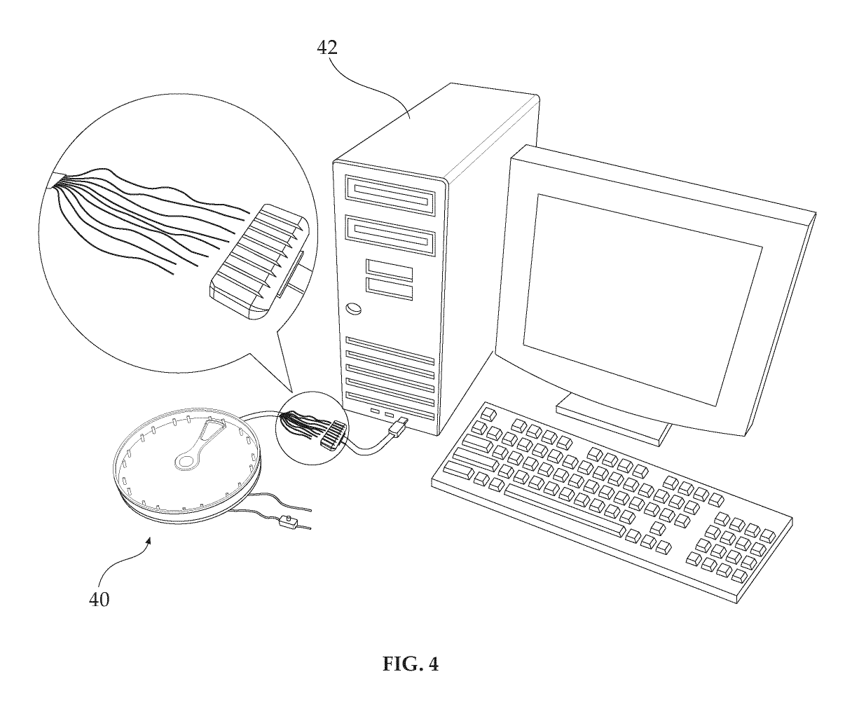

According to an alternative embodiment, as shown in FIG. 4, the electronic signaling system includes a multi-contact switch 40 coupled to a PC 42 for sending digital information to the PC. It will be appreciated that this system performs substantially the same way as with the cell phone but, instead of activating micro-switches, the sequence of circuit closures collected by the PC can be processed thereby as a code, for defining various sequences of operations to be performed by the PC, such as displaying a certain message on the monitor or sending an e-mail to a designated recipient, etc. In this case, one or a series of circuits are coupled via wires and a contact terminal to the PC.

The multi-contact switch with a PC may be utilized by a disabled person, allowing him to perform a series of actions by pressing one single button. Alternatively, if desired, one or more of the switches can be coupled to a cellular phone while another switch or switches are coupled to a PC.

It will be appreciated that the step motor can have one or more programs for a single multi-contact switch, each initiated by a different mechanical activity. On the same system, different programs can cause closure of pairs of contacts in various sequences, or different pairs of contacts, according to the desired results.

Alternatively, several multi-contact switches, each having its own program, may be driven by a single motor. Each multi-contact switch could have an arm oriented in a different orientation from the others, for electrically engaging different contacts at different layers of the system.

In addition, the electronic signaling system may be designed to selectably activate one or more of a plurality of multi-contact switches mounted on a shaft of a single motor. Selecting the multi-contact switches to be activated by the motor may be carried out, for example, by coupling each of the multi-contact switches to a selectable coupling mechanism mounted on the shaft. Such coupling mechanism may selectably lock the arm of the multi-contact switch, thereby permitting the rotational movement of the motor to be transferred to the arm of the pre-selected multi-contact switch. According to a preferred embodiment of the invention, the electric contact may be electronically controlled by a switch thus may provide for controlling the closing of the circuits in the multi-contact switch preferably by electronic means.

It will be appreciated that the system may have one or more multi-contact switches, each with its own pre-programmed step motor, each for performing a different sequence of operations, for example, sending an SMS through a cell phone to a pre-planned recipient. While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. An electronic signaling system comprising:
a multi-contact switch including
a plurality of pairs of contacts;
an electric contact for selectively engaging one of said pairs of contacts;
said pairs of contacts being electrically coupled to an electronic device for generating signals;
a motor for moving said electric contact to engage said pairs of contacts in a pre-selected sequence; and
means for generating an electrical signal for powering said electrical device.

2. The system according to claim 1, wherein said motor is an electric motor.

3. The system according to claim 1, wherein said electric contact is adapted for selectively engaging at least two of said pairs of contacts in a pre-selected sequence.

4. The system according to claim 1, further including a plurality of multi-contact switches.

5. The system according to claim 4, wherein said plurality of multi-contact switches is driven by a single motor.

6. The system according to claim 1, wherein said electric contact is electronically controlled by a switch adapted for selectively electrically coupling said pairs of contacts.

7. The system according to claim 4, wherein said multi-contact switches are coupled to a mechanism mounted on a shaft of said motor, selectively locking said arm of multi-contact switch, thereby permitting the rotational movement of the motor to be transferred to the arm of said multi-contact switch.

8. The system according to 5, wherein said multi-contact switches are coupled to a mechanism mounted on a shaft of said motor, selectively locking said arm of multi-contact switch, thereby permitting the rotational movement of the motor to be transferred to the arm of said multi-contact switch.

9. A method for electronic signaling, the method comprising:
providing a multi-contact switch including a plurality of pairs of contacts;
electrically coupling said pairs of contacts to an electronic device for generating signals;
mounting an electric contact on said multi-contact switch for selectively engaging one of said pairs of contacts; and
generating an electrical signal for powering an electrical device for moving said electric contact to engage said pair of contacts.

10. The method of claim 9, wherein said step of mounting includes mounting an electric contact on said multi-contact switch for selectively engaging at least two of said pairs of contacts in a pre-selected sequence.
